(19) United States
(12) Patent Application Publication
(10) Pub. No.: US 2014/0351174 A1
(43) Pub. Date: Nov. 27, 2014

(54) METHOD OF PROVIDING FRAGRANCE AS A DECOR ELEMENT

(71) Applicant: S.C. Johnson & Son Inc., Racine, WI (US)

(72) Inventors: Patricia Penman, Racine, WI (US); David D. Williams, Racine, WI (US); Axel Bayala, Racine, WI (US); Ellen Clark Arnold, Libertyville, IL (US)

(21) Appl. No.: 13/899,051

(22) Filed: May 21, 2013

(51) Int. Cl. G06Q 90/00

(52) U.S. Cl. CPC G06Q 90/00
USPC 705/500

(57) ABSTRACT

A method of providing a consumer with a fragrancing system to coordinate with their home décor comprising the steps of: (a) providing a palette of décor styles, wherein the palette comprises at least two décor styles; (b) providing a plurality fragrances, wherein at least one of the plurality of fragrances coordinates with at least one of the at least two décor styles; and wherein the wherein the décor style is shown on the fragrance or the palette with an indicator selected from the group consisting of: primary nomenclature and iconography.

### BACKGROUND OF THE DISCLOSURE

1. Field of the Disclosure

The present disclosure is directed to a method for using fragrance as a décor element, whether the fragrance be dispensed by a candle, essential oil diffuser, a sprayer and the like.

2. Background of the Related Art

Home décor is often featured on television on shows such as “Extreme Makeover: Home Edition” (ABC Studios) and “Property Brothers” (HGTV). These shows often provide examples of incredible renovations which are often extremely visually appealing and add tremendously to the ambiance of the home that has been renovated.

Fragrancing articles may be used to add to the ambiance of a home. Fragrance itself is also used to add to the ambiance of a home by providing scents which a consumer finds pleasant. In some instances, fragrances may be used to provide floral, citrus, or food scents to a consumer's home. In other instances, fragrances may be used to evoke pleasant memories based on the scent that is being used. An example is using a pumpkin pie scented candle to evoke fond holiday memories or provide pleasant thoughts to those smelling the fragrance. An additional example is formulating a scent with different elements to signify an event or a location such as mango or coconut which may be used to depict a tropical feeling.

Alternatively, fragrancing articles are sometimes used as actual décor elements themselves. For example, an article such as a candle or a scent dispenser, such as the Glade® Expressions sprayer or the Glade® Sense and Spray device (both of S.C. Johnson & Son, Inc., Racine, Wis.) may be placed in a consumer's home as a décor element.

In an effort to provide a high level of consumer engagement, interest and product consumption, a great deal of technology has been developed. For example, the technology behind plug in scented oils, sprayable air cleansing technology, and fragrance delivery forms is constantly upgraded. For example, see U.S. Pat. Nos. 3,583,642; 5,143,288; and 7,014,127.

Separating from scent or fragrance technology, there have been numerous efforts across a variety of retail lines to provide a “fragrance finder” of sorts. That is, a guide provided by retailers or manufacturers to consumers for choosing fragrances through the use of questionnaires that help put clarity around the consumers' underlying preferences.

For example, Macy's, Nordstrom, and Real Simple have online perfume fragrance finders which typically ask questions about scent preferences and contexts (i.e., occasion for use) and then directs the consumer to specific recommended perfumes.

For the home, there exist fragrance finders that are very similar to the aforementioned perfume finders. Illume (www.illumecandies.com) provides an online fragrance finder which asks the user to select two images that resonate with the user and then provides a list of fragrances which Illume recommends. Upon selecting one of the fragrances (which may be selected by the fragrance's name—each spelled out in different flavors, such as citrus, floral, etc.). Additionally, Glade® (S.C. Johnson & Son, Inc., Racine, Wis.) has an online fragrance finder which provides a series of questions—including what the user's dream home is—to provide a fragrance recommendation to that person for the room that they had initially selected at the beginning of the survey (www.gladehomestylestudio.com/Index.html).

### SUMMARY

While the existing fragrance and fragrance-finding solutions are effective in giving consumers one or more fragrance recommendations for their personal wear or home use, the existing solutions do not provide users with a true décor-focused experience. One particular drawback is that existing solutions require a complicated intermediate step of using some sort of fragrance finding tool which may not always be readily available. Further, there is a lack of at-shelf communication to clearly point users or consumers to the right fragrance for the occasion—leaving the consumer bewildered when she is at the shelf as to whether she is making the right decision with regard to coordinating her fragrance choice. The present technology solves this problem by providing a system by which fragrance and décor are clearly and easily coordinated for consumers and the present technology is particularly useful when utilized at-shelf.

Many consumers appreciate having a common design theme through their home. For example, a consumer with a modern kitchen is more likely to have modern appointments throughout her home as opposed to having a modern kitchen and a country-style living room.

Effectively marketing fragrances to consumers is partially dependent upon consumer acceptance and perception of the fragrances. Surprisingly, it was discovered that consumers believe that there is such a high level of fragrance saturation in the market wherein different brands each have their own lineup of fragrances and each fragrance is intended to provide different emotions, images, or feelings, that consumers often feel overwhelmed and confused that they are choosing the right fragrance for their home—that is, consumers feel that the theme of their home is being disrupted by the wrong fragrance. To further complicate the matter, design trends yearly—if not more often, and therefore having a fixed palette of fragrances does not necessarily give the consumer any guidance towards what fragrances completes their design vision.

By providing the consumer with fragrances (and not necessarily the fragrance dispensers) that are chosen by expert home designers to coordinate with the home décor or personal style rather than simply providing the consumer with fragrances that the consumer can choose to fit into her home, the fragrancing process is made easier and more convenient—thus making consumer acceptance of the product much more likely.

The subject technology presents an easy and efficient method of solving the discovered problem. By giving consumers fragrance choices that are designed, expertly endorsed, and/or otherwise specially selected to coordinate with one or more, and possibly evolving décor styles, consumers can easily complete their home design vision.

In one embodiment, the subject technology is a method of providing a consumer with a fragrancing system to coordinate with their home décor comprising the steps of: (a) providing a palette of décor styles, wherein the palette comprises at least two décor styles; and (b) providing a plurality fragrances, wherein at least one of the plurality of fragrances coordinates with each of the décor styles.

Another embodiment is directed to a plurality of fragrances wherein each of the fragrances has a primary nomenclature that coordinates with a décor style.

Still another embodiment is directed to a method of providing a consumer with a fragrancing system to coordinate with their home décor comprising the steps of: (a) providing a first brand to a palette of décor styles; (b) providing a second brand to a plurality of fragrances; (c) providing indicia from the second brand on the palette of décor styles; (d) providing indicia from the first brand on the plurality of fragrances; and wherein the first brand equity is associated with home décor expertise and wherein the second brand equity is associated with fragrance expertise.

It should be appreciated that the present technology can be implemented and utilized in numerous ways, including without limitation as a kit, a method, an apparatus, a system, a device, and a method for applications now known and later developed. These and other unique features of the technology disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a perspective view of a retail shelf space.

FIG. 2(a) is a front view of an exemplary fragrancing product form.

FIG. 2(b) is a front view of an exemplary fragrancing product form.

FIG. 2(c) is a front view of an exemplary fragrancing product form.

### DETAILED DESCRIPTION

As used herein “fragrancing system” means an array of two or more scents or fragrances that may be used in one or more areas of a home. Fragrancing systems explicitly refer to the actual scent or fragrance itself with the form (vessel) being irrelevant. A fragrance or fragrances may come in any product format. Fragrancing systems as used herein and as understood in relationship to décor explicitly excludes the vessel or form in which the fragrance is delivered (ex., candle, warmer, plug in, etc.) as a décor element.

As used herein “palette” means a range of a particular item or element (such as home décor styles) in a body of work. A palette may be modified from time to time.

As used herein a “décor style” means a theme that has common elements as defined by culture, a designer, or common-knowledge. Non-limiting examples of décor styles include: modern, classic, vintage, country-western, country cottage, urban, country French and the like.

As used herein “coordinates” means relating to in a positive sense as provided for, or otherwise endorsed by, an expert in the field of home décor or someone that holds themselves out as an expert in the field of home décor despite home décor not being their primary equity, such as the fragrance manufacturer.

As used herein “design leader” means an individual, group of individuals, or some source whose brand equity is primarily focused in the field of home décor or stylish living. An example of a design leader may be a television personality who provides design advice such as Nate Berkus or Martha Stewart.

As used herein “brand” or “branding” means a name, symbol, term, design, or some other indicator that identifies one seller's goods or services as distinct from those goods or services from a different seller.

As used herein “channel of trade” means the mode by which one seller of goods or services may provide those goods or services to consumers. For example, retail trade, television, online are all distinct channels of trade.

As used herein “primary nomenclature” means the particular item identifier or name given to a particular item. For example, an air care product from the Glade® (manufactured by S.C. Johnson & Son, Inc., Racine, Wis.) brand may be identified as “Hijinks” and then be described as comprising “pomegranate, lilies, and cherry blossom” scents. The primary nomenclature here is “Hijinks.” Primary nomenclature may be used as an indicator on a fragrance or on a palette.

As used herein “iconography” means the particular item visual or illustrated identifier given to a particular item. For example, an air care product from the Glade® brand may include a picture or illustration or icon of a particular building type or décor type which may be of any size on the product container. Such picture or illustration or icon is the iconography for the product. As used herein, iconography typically but not necessarily excludes pictures, illustrations or icons of flowers, fruits, herbs, beaches or foodstuff. Iconography is strictly limited to décor styles or architecture types. Iconography may be used as an indicator on a fragrance or on a palette.

The present disclosure overcomes many of the newly discovered problems associated with providing consumers a fragrance system to complete the design of their homes. The advantages and other features of the technology disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

Unless otherwise specified, the illustrated embodiments can be understood as providing exemplary features of varying detail of certain embodiments, and therefore, unless otherwise specified, size, shape, features, components, modules, elements, and/or aspects of the illustrations can be otherwise modified, combined, interconnected, sequenced, separated, interchanged, substituted, positioned, and/or rearranged without materially departing from the disclosed systems or methods. It is also noted that the accompanying drawings are somewhat idealized in that, for example without limitation, only one possible version of many is shown as would be appreciated by those of ordinary skill in the pertinent art.

In certain nonlimiting embodiments the fragrancing system comprises a plurality of fragrances and further provides a contextual use which may be indicated by its primary nomenclature. For example, rather than describing the scent (i.e., “tropics” to describe pineapples or “pumpkin pie” to describe pumpkin pie) the primary nomenclature may describe an intended use of the fragrance (i.e., “bathroom oasis” or “country cottage” would describe the type of home décor style or room that the fragrance is appropriate for). In a particular nonlimiting embodiment there may be one or more fragrances within the plurality that has primary nomenclature of a décor style rather than a primary nomenclature that is a a mere thematic scent description (ex., “urban” versus “pumpkin pie”). For an example, there may be four décor styles called out—urban, modern, classic, and seaside.

### Fragrances

In a nonlimiting embodiment the plurality of fragrances comprises two or more individual fragrances. In one embodiment there are about four to about twelve fragrances in the plurality. In another embodiment there are about four to about eight fragrances in the plurality. In some embodiments, at least some of the fragrances in the plurality fragrances have common scents. In other embodiments, none of the fragrances in the plurality of fragrances have any common scents.

In another nonlimiting embodiment, the plurality of fragrances are divided into two or more categories wherein each of the two or more categories corresponds with a different décor style. In one nonlimiting embodiment there is more than one fragrance in each category of décor style. In another nonlimiting embodiment there is only one fragrance in each category of décor style.

In many instances fragrances are given a primary nomenclature that corresponds with the fragrance's scent elements or is otherwise tied to the scent itself. For example, a Febreze® Air Effects® (The Procter and Gamble Co., Cincinnati, Ohio) product has a primary nomenclature of “Gain”—such primary nomenclature indicates that the product is scented as the corresponding laundry detergent. In another example, an Air Wick® 2 in 1 (Reckitt Benckiser, Inc., Parsippany, N.J.) product has a primary nomenclature of “Papaya and Mango”—such primary nomenclature indicates that the product is scented as the corresponding fruits. In another example still, a Glade® Spray (S.C. Johnson & Son, Inc., Racine, Wis.) has a primary nomenclature of “Budding Blossoms”—such primary nomenclature indicates that the product is scented as flowers.

In many instances fragrances are given a primary nomenclature that corresponds with the fragrance's scent elements or is otherwise tied to the scent itself. For example, a Febreze® Air Effects® (The Procter and Gamble Co., Cincinnati, Ohio) product has a primary nomenclature of “Gain”—such primary nomenclature indicates that the product is scented as the corresponding laundry detergent. In another example, an Air Wick® 2 in 1 (Reckitt Benckiser, Inc., Parsippany, N.J.) product has a primary nomenclature of “Papaya and Mango”—such primary nomenclature indicates that the product is scented as the corresponding fruits. In another example still, a Glade® Spray (S.C. Johnson & Son, Inc., Racine, Wis.) has a primary nomenclature of “Budding Blossoms”—such primary nomenclature indicates that the product is scented as flowers.

Compared to the existing primary nomenclature system, in some nonlimiting embodiments one novel and nonobvious element of the instant technology is that the primary nomenclature of at least one fragrance in the plurality of fragrances corresponds to a décor style. In other nonlimiting embodiments, the primary nomenclature of at least one fragrance in the plurality of fragrances corresponds to a specific room in the home. Nonlimiting examples of rooms in the home are: bathroom; living room; kitchen; bedroom; basement; combinations thereof and the like. Surprisingly, it was discovered that by providing users with a primary nomenclature corresponding to a décor style or room, users more readily accepted the fragrance as “belonging” in their home because the fragrance is prescribed as corresponding to that particular décor style or room. Also surprisingly, it was discovered that by providing an endorsement from a design leader or by providing a brand or branding to the fragrance that indicates approval from a design leader or someone whose primary equity is related to home décor or design, users readily accepted the fragrance as “belonging” in their home because the fragrance is prescribed by an expert in the decorating subject matter.

In some embodiments the actual scents which comprise each fragrance may be chosen by the fragrance manufacturer or designated by a brand or design leader. There is no struct rule to determine what fragrances coordinate with a particular décor style. A fragrance coordinates with a décor style so long as an expert in the field of home décor or someone that holds themselves out as such indicates that there is, in fact, coordination between the fragrance and the décor style.

In one nonlimiting embodiment, the plurality of fragrances may be refreshed, or otherwise changed, from time to time. In a particular embodiment, the plurality of fragrances may be refreshed, or otherwise changed, at least annually. There is no requirement for the décor palette to be refreshed, or otherwise changed, when there is a change in one or more of the fragrances in the plurality.

Décor Palette

Home owners, design leaders, designers, realtors, decorators, retailers, and the like often describe home décor according to certain themes or elements as defined by culture, a designer, or common-knowledge. Non-limiting examples of décor styles include: modern; classic; vintage; country-western; country cottage; urban; and the like.

In some nonlimiting embodiments, a décor palette comprises two or more décor styles. In one nonlimiting embodiment of the present technology, the user is provided with a décor palette which she may use to identify the type of home she wishes to complete decoration of from a scent perspective. Once the user determines the décor style which she wishes to use from the décor palette, then the user is directed to one or more fragrances that is said to coordinate with that décor palette. In some nonlimiting embodiments the primary nomenclature of the fragrance is substantially similar to, or descriptive of, the décor style rather than the scent elements within the fragrance. In other nonlimiting embodiments, the décor style is shown on the fragrance or the palette with an indicator selected from the group consisting of: primary nomenclature and iconography.

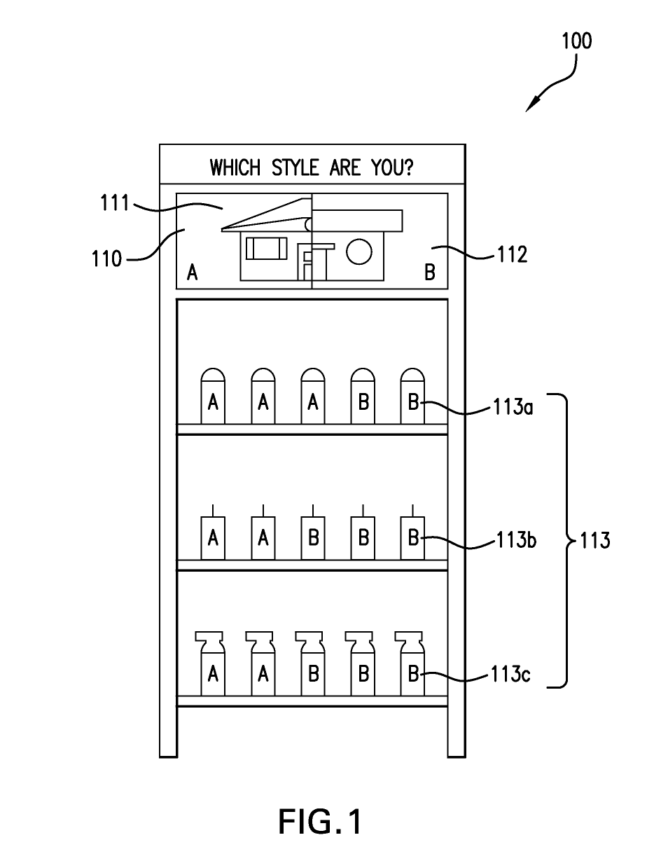

FIG. 1 shows an exemplary nonlimiting embodiment of a décor palette that may be used for an in-store or other retail display. A retail shelf 100 as it appears in a retail space. Supporting documentation 110 such as signage, a booklet, or an electronic display (TV, tablet, etc.) may be placed at or near the retail shelf 100. In one embodiment the supporting documentation 110 comprises a first décor style 111 and a second décor style 112 that is visually represented to the users to assist the user identify her décor style. In the example shown in FIG. 1, the supporting documentation 110 is a décor palette.

In a particular embodiment there may be an array of products 113 wherein the array comprises a variety of product forms 113a, 113b, 113c. The product forms 113a, 113b, 113c have different fragrances. Further, the product forms comprise an identifier (A, B) such as, but not limited to, primary nomenclature or artwork that relates to the décor styles (111, 112) that guides the user to which fragrance she should purchase to complete her décor or otherwise fit her décor style. In some embodiments the fragrances across the product forms 113a, 113b, 113c that belong to the same décor style are the same. In other embodiments the fragrances across the product forms 113a, 113b, 113c that belong to the same décor style are different.

In one nonlimiting embodiment, the décor palette may be refreshed, or otherwise changed, from time to time. In a particular embodiment, the décor palette may be refreshed, or otherwise changed, at least annually. There is no requirement for the plurality of fragrances to be refreshed, or otherwise changed, when there is a change in one or more of the décor styles in the décor palette. In a nonlimiting example, in year one, a color palette may comprise two décor styles: modern and classic. In year two, the color palette may be changed to comprise two additional décor styles: seaside and midcentury. There is no requirement that the fragrances used in year one change or remain the same.

### Endorsement/Multiple Branding

To improve a user's acceptance of a fragrance's belonging with a décor style, it may be desirable for the fragrance to be endorsed or otherwise substantiated by a design leader. Alternatively, providing a co-branded or singly branded product that provides the fragrance product with brand or branding of a design leader or another party which has its equity in home décor or design. In some embodiments the endorsement is shown on the fragrance. In other embodiments the endorsement is shown on the palette. In other embodiments still the endorsement is shown on both the fragrance and the palette.

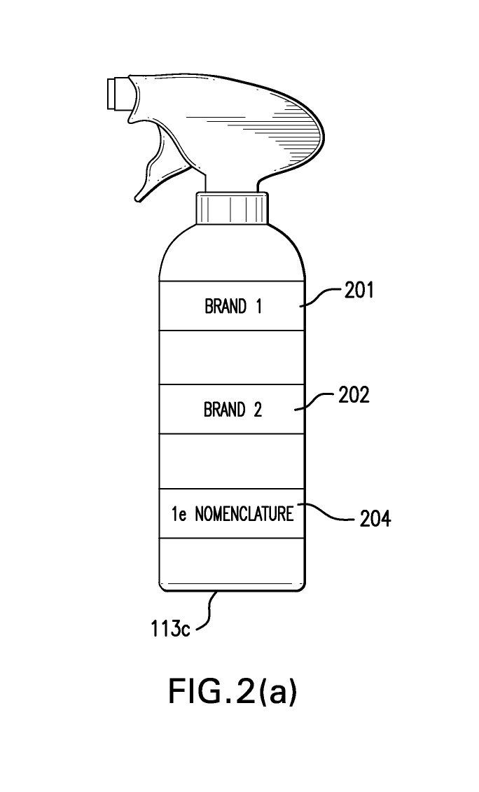

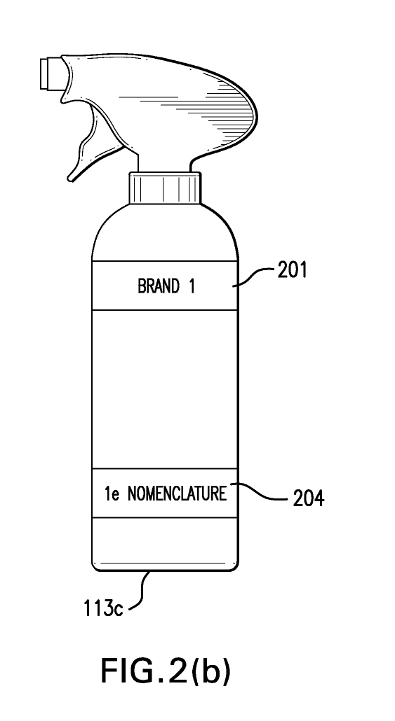

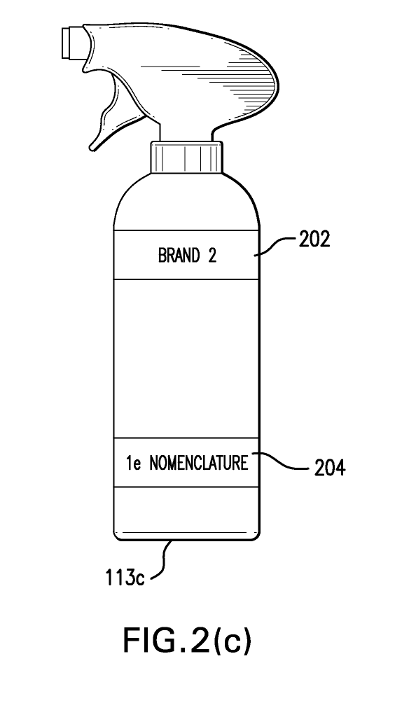

FIG. 2(a) provides an exemplary embodiment of a fragrance product in a particular product form 113c. In the example of FIG. 2(a) there is a first brand 201 provided and a second brand 202 provided. In the exemplary embodiment shown, the first brand 201 is the brand that relates to a design leader or other party which has its equity in home décor or design. In the exemplary embodiment shown the second brand 202 is the brand that relates to a party which has its equity in fragrance or air care. The product form 113c also provides a primary nomenclature 204 on the product form 113c that relates to a décor style or room.

FIG. 2(b) provides an exemplary embodiment of a fragrance product in a particular product form 113c. In the example of FIG. 2(a) there is a first brand 201 provided. In the exemplary embodiment shown, the first brand 201 is the brand that relates to a design leader or other party which has its equity in home décor or design. The product form 113c also provides a primary nomenclature 204 on the product form 113c that relates to a décor style or room.

FIG. 2(c) provides an exemplary embodiment of a fragrance product in a particular product form 113c. In the example of FIG. 2(a) there is a second brand 202 provided. In the exemplary embodiment shown, the second brand 202 is the brand that relates to a design leader or other party which has its equity in home décor or design. The product form 113c also provides a primary nomenclature 204 on the product form 113c that relates to a décor style or room.

Additional Consumer Guidance

There may be a consumer who has difficulty determining the particular style of her home. In these instances, it is possible that instructions or guidance of a design leader to help the consumer decide what elements in her home constitute particular designs. In other words, in certain instances, it may be preferred to provide instructions to consumers for identifying a design style. For example, a design leader may provide certain guidelines in that suggest the use of gears, Edison bulbs, or metal fans in one's home décor provides for an urban look or that the use of wicker, paisley and/or floral patterns, or stenciling/signage in one's décor provides for a traditional home style.

In some embodiments such guidance may be provided via online or printed material. In some other embodiments such guidance may be provided via online or printed survey. In yet other embodiments still such guidance may be printed directly on any product packaging material or at the retail location for reference by consumers.

### INCORPORATION BY REFERENCE

All patents, published patent applications and other references disclosed herein are hereby expressly incorporated in their entireties by reference.

While the invention has been described with respect to preferred embodiments, those skilled in the art will readily appreciate that various changes and/or modifications can be made to the invention without departing from the spirit or scope of the invention as defined by the appended claims. For example, each claim may depend from any or all claims in a multiple dependent manner even though such has not been originally claimed.

We claim:

1. A method of providing a consumer with a fragrancing system to coordinate with their home décor comprising the steps of:
a. providing a palette of décor styles, wherein the palette comprises at least two décor styles; and
b. providing a plurality fragrances, wherein at least one of the plurality of fragrances coordinates with at least one of the at least two décor styles,
wherein the wherein the décor style is shown on the fragrance or the palette with an indicator selected from the group consisting of: primary nomenclature and iconography.

2. The method of claim 1 further comprising the step of:
c. providing the consumer with instructions for choosing a fragrance which coordinates with a design style.

3. The method of claim 1 further comprising the step of:
c. providing the consumer with instructions for identifying a design style.

4. The method of claim 3 further comprising the step of:
d. providing an endorsement from a design leader that supports the coordination of the at least one fragrance with the at least décor style.

5. The method of claim 4 further comprising
e. providing the branding from an air care brand on the fragrances.

6. The method of claim 1 wherein the palette of décor styles is selected from the group consisting of: modern, classic, vintage, country-western, country-cottage, urban, and the like.

7. The method of claim 1 wherein the palette of décor styles is updated at least annually.

8. The method of claim 1 wherein the plurality of fragrances is updated at least annually.

9. A plurality of fragrances wherein each of the fragrances has an indicator that coordinates with a décor style wherein the indicator is selected from the group consisting of: primary nomenclature and iconography.

10. The palette of décor styles according to claim 9 is selected from the group consisting of: modern, classic, vintage, country, urban, and the like.

11. The palette of décor styles according to claim 9 wherein the palette of décor styles is updated at least annually.

12. A method of providing a consumer with a fragrancing system to coordinate with their home décor comprising the steps of:
a. providing a first brand to a palette of décor styles;
b. providing a second brand to a plurality of fragrances;
c. providing indicia from the second brand on the palette of décor styles; and
d. providing indicia from the first brand on the plurality of fragrances;
wherein the first brand equity is associated with home décor expertise and wherein the second brand equity is associated with fragrance expertise.

13. The method according to claim 12 wherein the first brand is not associated with consumer goods.

14. The method according to claim 12 wherein the second brand is associated with consumer goods.

15. The method according to claim 12 wherein the first brand and the second brand are associated by consumers with different channels of trade.

16. The method according to claim 15 wherein the primary branding is associated with televised media as the channel of trade and the secondary branding are associated with retail stores as the channel of trade.

17. The method of claim 12 further comprising the step of:
e. providing the consumer with instructions for choosing the fragrance which coordinates with the design style.

18. The method of claim 12 further comprising the step of:
e. providing the consumer with instructions for determining what décor style their house comprises.

19. The method of claim 12 wherein the palette of décor styles is updated at least annually.

20. The method of claim 12 wherein the plurality of fragrances is updated at least annually.
